(19) United States
(12) Patent Application Publication
(10) Pub. No.: US 2002/0157633 A1
(43) Pub. Date: Oct. 31, 2002

(54) Antivibration device

(76) Inventors: Johannes Menzel, Stuttgart (DE); Markus Keller, Leutenbach (DE); Helmut Lux, Waiblingen (DE); Christoph von Hiller, Stuttgart (DE); Gunter Wolf, Oppenweiler (DE)

Correspondence Address: Walter Ottesen, Patent Attorney, P.O. Box 4026, Gaithersburg, MD, 20885-4026, US

(21) Appl. No.: 10/133,586

(22) Filed: Apr. 29, 2002

(30) Foreign Application Priority Data
Apr. 28, 2001 (DE) 101 21 029.9

(51) Int. Cl. F02B 75/06

(52) U.S. Cl. 123/192.1

(57) ABSTRACT

An antivibration device is mounted between a motor unit (1) having an internal combustion engine (2) and a vibration-insulated unit (3) of a portable handheld work apparatus (4) such as a motor-driven chain saw, cutoff machine, suction/blower apparatus or the like. The antivibration device (5) includes a vibration damper (6) made of foamed elastic material (7).

### BACKGROUND OF THE INVENTION

The internal combustion engine of a portable handheld work apparatus such as a motor-driven chain saw, a cutoff machine, suction/blower apparatus or the like generates oscillations in its rpm range. These oscillations are, for example, noticeable as vibrations in a handle for guiding the work apparatus. A further component of the oscillatory excitation is regularly generated by the tool which is driven by the engine. The tool can, for example, be a saw chain, a cutoff disc, a cutting knife or the like. The oscillations generated thereby in the handle can lead to a premature tiring of the operator.

There are many embodiments of work apparatus known wherein, for example, a handle is fixed to the motor unit of the work apparatus via an antivibration device. The antivibration device is intended to provide vibration insulation of the handle from the motor unit. One such antivibration device includes a rubber vibration damper with combined elastic and damping characteristics. A decoupling of vibration can be adjusted via a targeted dimensioning of the elastic characteristics. A portion of the vibration amplitudes, which are transmitted nonetheless to the handle element, can be damped by the material characteristics of the rubber.

The essentially non-linear material characteristics of the rubber can be disadvantageous in this context. For example, the stiffness of a rubber element increases with larger deflections and is essentially caused by its significant transverse expansion. As a consequence, the resonance frequency of the vibrating system made up of the motor unit, the handle, the intermediately connected antivibration element or device changes in dependence of the preload and the vibration amplitude. An adaptation of the resonance frequency to the operating frequency range of the work apparatus is therefore difficult. An operation of an antivibration element of this kind in a quasi-linear range is only possible for a correspondingly large configuration of the antivibration element for which sufficient mounting space is not always available. High operating loads or tight spatial conditions require the arrangement of a vibration damper, for example, in a sleeve, which prevents the transverse expansion of the damper material. Blocking the transverse expansion leads, with rubber, to a considerable stiffening, which makes an adaptation to the excitation frequencies to be dampened difficult.

A further disadvantage of rubber as a material for a damping element lies in its frequency-dependent stiffness. At high frequencies, the elasticity module of the rubber material increases. For an adequate vibration decoupling at high excitation frequencies, a very soft dimensioning of the antivibration element is required, which, under some circumstances, can lead to an excessively soft connection of the handle element to the motor unit. A clean guidance of the work apparatus is therefore hindered.

Further disadvantages can occur because of the stiffening of the rubber material at low temperatures or because of deterioration. A constructively pregiven vibration decoupling can then, under some circumstances, no longer be achieved practice.

In alternate embodiments, antivibration elements having steel springs are known whose spring characteristics are essentially constant or linear. However, the low material damping of the steel is here disadvantageous and can lead to unwanted resonances. An antivibration element having a vibration damper of steel is furthermore sensitive with respect to material fatigue.

### SUMMARY OF THE INVENTION

It is an object of the invention to provide an antivibration device having an improved damping effect.

The antivibration device of the invention is between a motor unit including an internal combustion engine and a vibration-insulated unit of a portable handheld work apparatus including a motor-driven chain saw, cutoff machine, suction/blower apparatus or the like. The antivibration device includes: a vibration damper interposed between the units and the vibration damper being made of a foamed elastic material.

For the above, the antivibration device is provided with a vibration damper made of foamed elastic material. It is practical to provide the elastic material in the form of a polyurethane foam whose pores have a volume portion in the range of between approximately 50 and 65% of the total volume. A material of this kind exhibits low fatigue. The amplitude dependency and frequency dependency of its material characteristics are likewise low.

The transverse expansion of the material is low when there is a longitudinal load especially because of the compressibility of the pores. The stiffness of the antivibration element can be dimensioned adequately high for a reliable guidance of the work apparatus. Because of the slight increase of material stiffness at high excitation frequencies, a good vibration decoupling is provided, for example, of a vibration-insulated handle unit against the vibrations of a high rpm engine. The slight transverse expansion of the material also permits the use of corresponding antivibration elements in spatially tight mounting surroundings. Generally, a small dimension of the vibration damper can be achieved. The temperature influence on the material characteristics is also low especially when utilizing polyurethane foam so that also a good damping effect can be achieved in an increased temperature range, for example, from −40° C. to approximately 110° C.

In a practical embodiment, the vibration damper is especially restrained with respect to its transverse expansion by a sleeve surrounding the vibration damper. With a corresponding configuration of the sleeve or of a corresponding formed part, a high mechanical loadability of the antivibration device and especially the avoidance of unwanted thrust deformations is provided. The wanted spring characteristics are retained also in a closed mounting space because of the low transverse expansion, especially of the elastic polyurethane foam.

In a practical embodiment, a vibrating system is formed from the motor unit, which is the unit insulated with respect to vibration by the antivibration device, and the vibration device itself. The resonance frequency and especially the √2-multiple of the resonance frequency of this vibrating system lies below the lower limit of the frequency range which is to be damped. The lower limit of the frequency range, which is to be damped, is defined by the idle rpm of the engine. In this way, the work apparatus is operated in the so-called overcritical range in that the enlargement function of the vibrating system lies below 100%. The vibration level at the vibration insulated unit such as a handle or the like is low in this way over the entire operating range of the engine.

In an advantageous embodiment, the vibration-insulated unit is a handle unit connected via the antivibration element to the motor unit. The handle unit is charged with only a slight frequency level. The motor unit itself can, however, be aligned rigidly, with respect to the work tool to be driven. As a consequence, misalignments are avoided.

### BRIEF DESCRIPTION OF THE DRAWINGS

The invention will now be described with reference to the drawings wherein:

FIG. 1 is a rearward end view of a motor-driven chain saw by way of example having a motor unit and a tubular handle fixedly mounted thereon via antivibration elements;

FIG. 2 is a schematic of an antivibration element having a vibration damper enclosed in a sleeve;

FIG. 3 is a variation of the antivibration element of FIG. 2 showing a vibration damper unrestrained in its transverse expansion;

FIG. 4 is another variation of an antivibration element having a vibration damper essentially pressure loaded; and,

FIG. 5 is an exemplary illustration of an enlargement function V_{D} of the arrangement of FIG. 1 as a function of frequency (f).

### DESCRIPTION OF THE PREFERRED EMBODIMENTS OF THE INVENTION

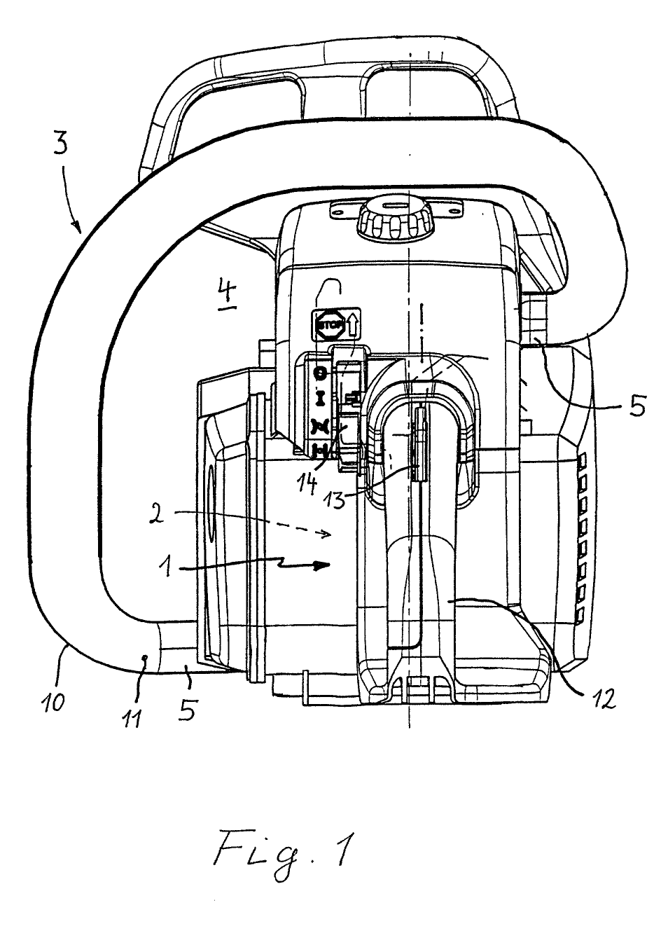

FIG. 1 shows a rearward view of a portable handheld work apparatus 4, such as a motor-driven chain saw. The work apparatus 4 can also be a cutoff machine, a suction/blower apparatus, a brushcutter or the like. The work apparatus 4 includes a motor unit 1 having an internal combustion engine 2. A rearward handle 12 is mounted on the motor unit 1 and includes a lock lever 13 for a throttle lever (not shown) as well as an actuating lever 14 for an automatic stop of the engine 2. A handle unit 10 in the form of a tubular handle 11 is fixed to the motor unit 1 with two antivibration elements 5. The tubular handle 11 thereby defines a vibration-insulated unit 3. A common configuration of a tubular handle 11 and of the handle 12 as a vibration-insulated handle unit 10 can also be practical. A further possibility comprises fixing the engine 2 in the apparatus housing via antivibration elements 5 whereby the apparatus housing together with the handle unit 10 becomes a vibration-insulated unit 3. The motor unit 1 can also be, for example, the unit made up of an internal combustion engine and a guide tube of a brushcutter wherein a handle bracket or a guide handle is fixed to the guide tube via an antivibration element 5 according to the invention.

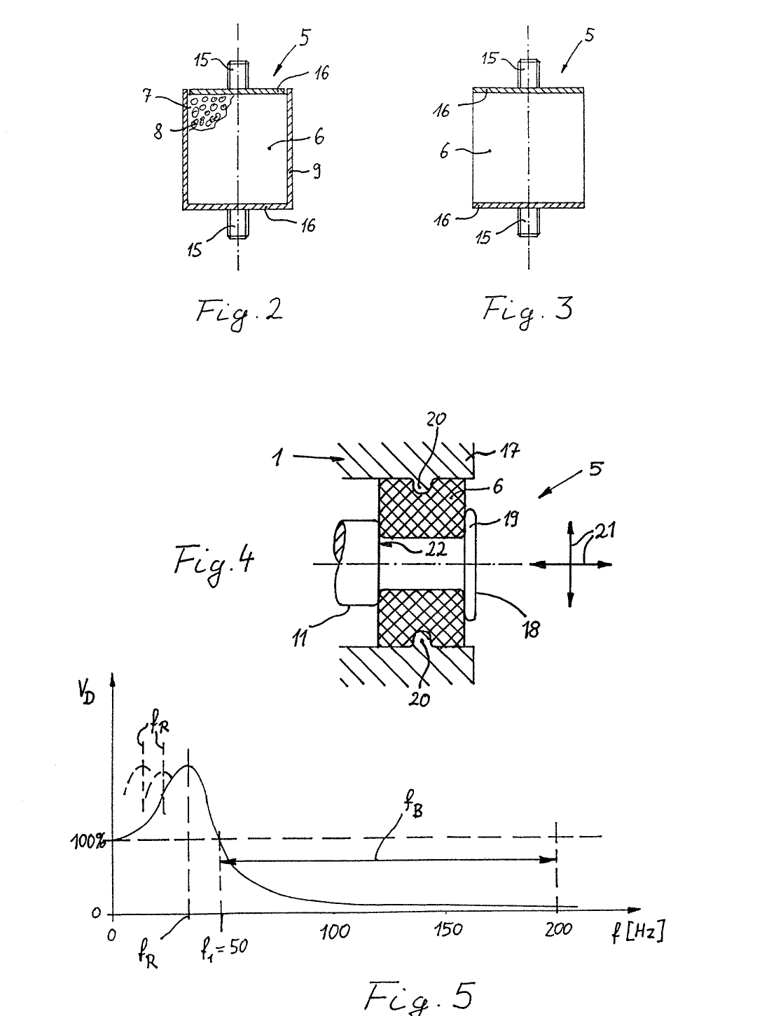

FIG. 2 is a schematic showing an antivibration element 5 corresponding to FIG. 1. The antivibration element 5 has a vibration damper 6. Plates 16 having respective threaded pins 15 for fixing the antivibration element 5 are arranged at respective ends of the vibration damper 6 in the axial direction. One of the end plates 16 is configured as one piece with a sleeve 9 enclosing the vibration damper 6. The transverse expansion, which is caused by an axial loading of the vibration damper 6, is prevented by the sleeve 9. In lieu of the sleeve 9, a wall of the tubular handle 11 or of the apparatus housing of FIG. 1 can be provided. In the embodiment shown, the vibration damper 6 has a cylindrical shape but can have any desired other suitable form depending upon the application. For example, the vibration damper 6 can have an irregular form. The vibration damper 6 is manufactured from a foamed elastic material 7 which is an elastic polyurethane foam in the embodiment shown. The polyurethane foam has pores 8 whose volume portion of the total volume of the elastic material 7 is preferably between 50 and 65% and is approximately 60% in the embodiment shown.

FIG. 3 shows a variation of the antivibration element 5 of FIG. 2 wherein the vibration damper 6 is held between two plates 16 having respective threaded pins 15. Especially with the omission of a sleeve 9 (FIG. 2) surrounding the vibration damper 6, a transverse expansion of the vibration damper 6 is possible for an axial load as well as for a thrust deformation.

A further embodiment of an antivibration element 5 is shown in FIG. 4 wherein the vibration damper 6 is mounted between an end 18 of the tubular handle 11 and a housing 17 of the motor unit 1. A bent-over flange 19 is provided at the end 18 of the tubular handle 11. The housing 17 includes a peripherally extending annular bead 20. The vibration damper 6 is held form-tight by the flange 19, the annular bead 20 and an offset or step 22 in the tubular handle 11. The arrangement shown permits vibration degrees of freedom essentially in the direction of double arrows 21 wherein the vibration damper 6 is primarily subjected to pressure stresses.

The motor unit 1 and the tubular handle 11 with the intermediately disposed antivibration elements 5 of FIG. 1 form a vibrating system whose vibration excitation takes place essentially because of the engine 2 and the saw chain (not shown). The vibration response in the tubular handle 11 dependent upon the excitation frequency is shown, by way of example, in the form of a diagram in FIG. 5. The trace of the vibration response is shown as an enlargement function V_{D} referred to the 100% line of the excitation amplitude. The useable rpm range of the engine 2 of FIG. 1 lies between the idle rpm of approximately 3,000 rpm and the full-load rpm of approximately 12,000 rpm. This corresponds to an excitation frequency range f_{B} from 50 to 200 Hz to be damped. The excitation frequency range of the saw chain lies, in the embodiment shown, in the range between 50 and 80 Hz and therefore within the frequence range f_{B} which is generated by the engine 2.

The vibrating system includes several resonance frequencies f_{R} and is shown in such a manner that its highest resonance frequency f_{R} amounts to approximately 30 Hz. Accordingly, the √2-multiple of the highest resonance frequency f_{R} lies slightly below the lower limit f₁ of the frequency range f_{B}, which is to be damped, at a level of 50 Hz. At excitation frequencies above the √2-multiple of the resonance frequency f_{R}, the enlargement function V_{D} runs below the 100% line as a consequence of which the vibration amplitude in the vibration-insulated unit 3 (FIG. 1) is less than the excitation amplitude and whereby an effective vibration damping is given in the vibration-insulated unit 3. The structural components of the work apparatus 4 of FIG. 1 such as the tubular handle 11, the handle 12 and the apparatus housing are dimensioned to be stiff so that their natural resonance lies above the excitation frequency range f_{B}. In this way, an effective vibration decoupling of the vibrating system from the natural vibrations of the individual structural components is given.

It is understood that the foregoing description is that of the preferred embodiments of the invention and that various changes and modifications may be made thereto without departing from the spirit and scope of the invention as defined in the appended claims.

What is claimed is:

1. An antivibration device between a motor unit including an internal combustion engine and a vibration-insulated unit of a portable handheld work apparatus including a motor-driven chain saw, cutoff machine, suction/blower apparatus or the like, the antivibration device comprising: a vibration damper interposed between said units and said vibration damper being made of a foamed elastic material.

2. The antivibration device of claim 1, wherein said foamed elastic material is a polyurethane foam.

3. The antivibration device of claim 2, wherein said foamed elastic material has pores and said pores constitute a volume portion in a range approximately from 50% to 65% of the total volume.

4. The antivibration device of claim 1, further comprising means for hindering a transverse expansion of said vibration damper.

5. The antivibration device of claim 4, wherein said means is a sleeve surrounding said vibration damper.

6. The antivibration device of claim 1, wherein said motor unit, said vibration-insulated unit and said antivibration device conjointly define a vibratory system having a resonance frequency (f_{R}) which lies below the lower limit (f₁) of a frequency range (f_{B}) to be damped.

7. The antivibration device of claim 6, wherein the √2-multiple of said resonance frequency (f_{R}) lies below the lower limit (f₁) of said frequency range (f_{B}) to be damped.

8. The antivibration device of claim 6, wherein said lower limit (f₁) of said frequency range (f_{B}) to be damped is defined by the idle rpm of said internal combustion engine.

9. The antivibration device of claim 1, wherein said vibration-insulated unit includes a handle unit connected to said motor unit via said antivibration device.
